(19) United States
(12) Patent Application Publication
(10) Pub. No.: US 2017/0096936 A1
(43) Pub. Date: Apr. 6, 2017

(54) GAS TURBINE ASSEMBLY

(71) Applicant: Siemens Aktiengesellschaft, Munich (DE)

(72) Inventor: Ulf Nilsson, Whetstone, Leicester (GB)

(73) Assignee: Siemens Aktiengesellschaft, Munich (DE)

(21) Appl. No.: 15/128,251

(22) PCT Filed: Apr. 2, 2015
(86) PCT No.: PCT/EP2015/057422

§ 371 Date: Sep. 22, 2016

(30) Foreign Application Priority Data
Apr. 11, 2014 (EP) 14164387.4

(51) Int. Cl. F02C 3/10; F02C 9/20; F02C 7/05; F02C 7/143

(52) U.S. Cl. CPC F02C 3/10; F02C 7/143; F02C 9/20; F02C 7/05; F05D 2260/607; F05D 2260/85; F05D 2260/90; F05D 2270/306

(57) ABSTRACT

A gas turbine assembly having a first shaft, a first compressor and a first turbine mounted on the first shaft, a combustor between the first compressor and the first turbine and a second shaft and a second turbine mounted on the second shaft, the second turbine having an inlet connected to an outlet of said first turbine. The gas turbine assembly further includes a third shaft on which an upstream compressor is mounted, the upstream compressor having an outlet which is connectable to an inlet of the first compressor.

### CROSS REFERENCE TO RELATED APPLICATIONS

This application is the U.S. National Stage of International Application No. PCT/EP2015/057422 filed Apr. 2, 2015, and claims the benefit thereof. The International Application claims the benefit of European Application No. EP14164387 filed Apr. 11, 2014. All of the applications are incorporated by reference herein in their entirety.

### FIELD OF INVENTION

The present invention relates to a gas turbine assembly. Furthermore, the present invention relates to a method for upgrading a gas turbine assembly. Moreover, the present invention relates to a method for operating a gas turbine.

### ART BACKGROUND

The drive for lower weight and cost directs the design of new compressors towards high specific flow, i.e. to maximize the mass flow of air sucked into the compressor for a given speed. This has the effect of also maximizing the possible pressure ratio per stage. This optimization means that there is very little or no possibility to increase the mass flow once the compressor is designed. The improvements are typically confined to increasing pressure ratio and/or efficiency. This approach can lead to benefits in a gas turbine having a twin shaft arrangement, with a gas generator including a first shaft and a power turbine mounted on a second shaft. A gas generator, which typically comprises one or more pairs of, a compressor and a turbine, each mounted on the same shaft, and one or more combustor(s) downstream of the compressor with the highest discharge pressure, is a turbomachine unit which is used for delivering gas at certain conditions of pressure and temperature.

A way of providing additional electric power, when needed i.e. during periods of high consumption, is achievable by means of air storage power plants. Air storage power plants have been used since the beginning of the gas turbine era. Compressors driven by electrical motors fills an underground cavity e.g. a decommissioned mine with compressed air when electricity is in surplus from the grid, particularly at nights. When there is a shortage of electricity, particularly during daytime, the air is released from the storage via combustion chambers to turbines driving electrical generators feeding electricity into the grid.

As far as mass flow rate in a gas turbine is considered, another aspect to be considered is the emission control at partial load, particularly of carbon monoxide (CO). In a single shaft constant speed gas turbine this is accomplished by closing the Variable Guide Vanes (VGVs), typically a reduction in mass flow rate by as much as 50% is achievable. The mass flow rate from the compressor can be reduced whilst maintaining the firing temperature which results in an increase in exhaust temperature due to the reduced pressure ratio, beneficial for heat generation or combined cycle operation. For example, the firing temperature may be kept constant down to 85% load, before the exhaust temperature reaches its maximum value, is then kept constant whilst the mass flow rate and firing temperature is decreased further as the load is reduced. For a twin shaft gas turbine, where the gas generator is mechanically disconnected from the power turbine, the power output and the mass flow rate are typically controlled by the firing temperature, from which they cannot easily be made independent. The firing temperature cannot, therefore, be kept constant at partial load, without further measures, such as creating parasitic losses. In such cases, the established approach addressing CO emission control is to bleed off air from the compressor discharge to the turbine exhaust, in order to raise the fuel to air ratio inside the combustor i.e. using a higher firing temperature than would otherwise be required to compensate for the parasitic loss or, alternatively, to recirculate bled air to the compressor inlet with the same purpose. Both approaches have the effect of raising the fuel/air ratio in the combustor which is beneficial for reducing CO emissions. For example utilising these parasitic loss techniques could enable the twin shaft gas turbine to operate at a firing temperature corresponding to a 20% higher load, e g the same temperature at 80% load as for 100% (full) load. The load shift as a percentage value will depend on how much air that can be extracted from the compressor and also what maximum value of turbine exhaust temperature that can be used. As with all losses the parasitic loss will generate a reduction in the gas turbine cycle efficiency.

As an alternative to the approach above, it is also known to provide the power turbine of a twin shaft gas turbine with an inlet VGV. The main drawback of such solution is that, with increasing turbine inlet temperatures, moving parts in or near the main gas path tend to suffer from a lower reliability and increased service/maintenance requirements.

Some partial load emission controls can be handled by controlling directly the combustor itself. A portion of the combustion air can be removed from the fuel air mixing process and then injected as dilution air downstream of the flame, but upstream the turbine inlet. The portion of air bypassing the flame in this way can be controlled via a valve arrangement.

The burner in the combustor has a so called “natural turndown”, referring to the temperature range within which the corresponding fuel flow, i.e. the load, can vary without changing the relative distribution of fuel between the different injection ports whilst maintaining a stable and efficient flame. For example this temperature range may correspond to the top 20% of the load range.

The techniques described above can be used on their own or in combination to define an emission control configuration.

FIG. 2 shows a conventional twin shaft gas turbine assembly 200 including a gas generator 110. The gas generator 110 comprises a first shaft 101, on which a first compressor 102 and a first turbine 103 are mounted. The first compressor 102 is a high specific flow compressor, i.e. a compressor specifically designed to maximize the mass flow of air sucked into the compressor for a given speed of its shaft, which also maximizes the pressure ratio. A combustor 104 is provided between the first compressor 102 and the first turbine 103. In the combustor 104 a fuel is injected burnt with the aid of the compressed air, working as a combustive, coming from the first compressor 102. After the burning process, a hot gas comprising combustion products exits the combustor 104 and enters the first turbine 103 where the gas is expanded. From an outlet 103b of the first turbine 103 the expanded gas is delivered to an inlet 206a of a second power turbine 206 which is mounted on a second shaft 205. In the second power turbine 206 the gas is further expanded in order to generate a mechanical power output which is transferred to an electric generator 212 mounted on the second shaft 205. After the expansion in the second turbine 206, the gas is released to the atmosphere through an outlet 206b of the second turbine 206.

FIG. 3 shows another conventional twin shaft gas turbine assembly 200 including a different example of gas generator 121. Gas generator 121 includes a plurality of compressors (three compressors 112, 114, 116, in FIG. 3) each running at a different speed. Gas generator 121 includes also a plurality of turbines (three turbines 113, 115, 117, in FIG. 3), each turbine being mechanically connected, by means of a respective shaft 118, 119, 120, (or by means of other mechanical couplings) to one of the plurality of compressors 112, 114, 116, respectively. Looking in the flow direction of FIG. 3 the three compressors 116, 114, 112, combustor 104 and the three turbines 113, 115, 117 are connected in series. The reason as to why the single compressor-turbine arrangement of the gas generator 110 is divided up in the plurality of compressor-turbine pairs arrangement of the gas generator 121 is that of allowing a higher speed of the compressor-turbine pair as the pressure increases and the compressor and turbine are, as a consequence, smaller. The smallest compressor 112 and smallest turbine 113 can rotate at the highest speed with respect to the other pairs, while the biggest compressor 116 and biggest turbine 117 can rotate at the lowest speed. This arrangement is beneficial in terms of efficiency.

In an alternative embodiment (not shown) the shafts 118, 119, 120 may also be arranged concentrically rather than parallel as show in FIG. 3. In that case shaft 119 would run through the centre of shaft 118 and in the same way shaft 120 would run through shaft 119.

### SUMMARY OF THE INVENTION

It may be an object of the present invention to provide a gas turbine assembly enabling an increase in mass flow rate for a twin shaft gas turbine even when it comprises a high specific flow compressor gas generator. It may be a further object of the present invention to provide a gas turbine assembly enabling an increase in partial load efficiency with reduced partial load emissions (e.g. CO emissions).

In order to achieve the objects defined above, a gas turbine assembly, a method for upgrading an existing gas turbine and a method for operating a gas turbine according to the independent claims are provided. The dependent claims describe advantageous developments and modifications of the invention.

According to a first exemplary embodiment of the present invention, a gas turbine assembly comprises a first shaft, a first compressor and a first turbine mounted on the first shaft, a combustor between the first compressor and the first turbine, and a second turbine having an inlet connected to an outlet of the first turbine, wherein the gas turbine assembly further comprises a third shaft on which a controllable motor and an upstream compressor are mounted, the upstream compressor having an outlet which is connected to an inlet of the first compressor, the controllable motor varies the speed of the third shaft and upstream compressor independently from an air flow passing through the upstream compressor, the air flow is ducted through the upstream compressor and the first compressor in series..

The first compressor, first turbine, first shaft and combustor define a single unit which may be normally referred to as “gas generator”. In a gas generator the turbine delivers an expanded gas at certain conditions of pressure and temperature while the mechanical power generated by the turbine is mainly used to drive the compressor. The second turbine, which receives an expanded gas from the first turbine and generates a more significant power output, can be advantageously connected to an electrical generator for electrical power generation or drive any mechanical load, e.g. a pump. In such cases, the second turbine may be referred to as “power turbine”. A gas turbine including a gas generator with one or more shaft and a power turbine mounted on another shaft, different from those included in the gas generator, may be referred to as a “twin shaft gas turbine”.

By “upstream compressor” it is meant a compressor generating a flow of compressed air which is delivered to the gas generator.

Advantageously, the presence of a compressor upstream the first compressor allows to achieve an increase in the mass flow rate flowing in the gas turbine. The upstream compressor allows also to achieve an increase in the power output of the gas turbine, which is proportional to the pressure ratio of the upstream compressor. In addition, in order to operate at partial load, the air flowing in the upstream compressor can be advantageously disconnected from the gas flowing through the power turbine, thus enabling to reduce the mass flow through the gas turbine while maintaining the pressure ratios for the first compressor and the turbines at their optimum. Therefore, emissions control (in particular CO emissions) can be performed at a lower load percentage without the need to bleed off air from the compressor output to the combustor exhaust. If for example the air provided by the upstream compressor resulted in a doubling of the net output from the gas turbine, the load could be reduced to 50% before applying any emission control actions compared to a conventional twin shaft gas turbine i.e. bringing the control range equal or beyond the partial load which can be reached in a single shaft gas turbine with VGV control on the compressor. For the gas turbine of the present invention, even lower partial load ranges can in any case be reached by using compressor air bleed to control the CO emissions.

Advantageously, having both compressors in series allows us to use a common air filtration system.

The upstream compressor may be driven by any means that allows the speed to be independently variable. It may for example be a hydraulic motor or a reciprocating engine.

According to a further exemplary embodiment of the present invention, the gas turbine assembly comprises a variable speed electrical motor connected to the third shaft for driving the upstream compressor.

The electrical motor allows to operate the upstream compressor at variable speed independently from the first compressor. In addition, having an upstream compressor outlet connected with the first compressor inlet removes, with respect to other traditional solutions, the need for space for a conventional starter motor active on the first compressor. In the inventive gas turbine assembly is the upstream compressor rotation to blow air through the first compressor by using the electrical motor.

The fact that the upstream compressor can be independently operated from the first compressor also allows to operate efficiently the gas turbine assembly of the present invention during start-ups. A method for operating the gas turbine assembly of the present invention, comprises increasing the speed of the upstream compressor to increase the speed of the first shaft until ignition conditions in the combustor are reached, then continuing to control (e.g. vary) the speed of the upstream compressor in order to raise the pressure ratio over the first turbine, then reducing the speed of the upstream compressor until the second turbine starts to generate mechanical power. By “ignition conditions” it is meant a set of values of fuel/air mixture, mass flow rate and pressure which permits to achieve ignition in the combustor. These values are linked to the value of the speed of the first shaft.

After ignition achievement, the speed of the upstream compressor is still controlled in order to move the gas turbine assembly towards “idle conditions”, i.e. conditions at which the power turbine rotates but the mechanical power generated equals zero. Depending on the efficiency of the first compressor and first turbine, a different action may be required by the upstream compressor or can be accepted by the combustion chamber in order to prevent the flame from extinguishing. In this phase therefore, the speed of the upstream compressor may increase, stay constant or decrease, such that the pressure ratio over the first turbine is raised and a steady acceleration of the gas generator is achieved without raising the pressure ratio over the first compressor. This enables the first turbine to produce more power and accelerate the gas generator further or faster than had the upstream compressor not been used. As idle conditions are further approached the pressure at the inlet of the first compressor can be lowered the speed of the upstream compressor, as, at this phase, the efficiencies of the first compressor and of the first turbine are sufficiently high to maintain the acceleration. After idle conditions have been crossed, i.e. after the second turbine has started producing mechanical power the speed of the upstream compressor can be increased again.

According to an embodiment of the present invention, the upstream compressor has a pressure ratio of 1/3 of the pressure ratio for the first compressor or lower.

According to a further embodiment of the present invention, the upstream compressor has a pressure ratio of 1/5 of the pressure ratio for the first compressor or lower.

According to an even further embodiment of the present invention, the upstream compressor has a pressure ratio of 1/10 of the pressure ratio for the first compressor or lower.

A limited pressure ratio permits also to limit the overall pressure ratio of the first and upstream compressor which would result in an air discharge temperature at the first compressor outlet exceeding the material limits of the centre section of the gas turbine.

According to a further exemplary embodiment of the present invention, the gas turbine includes an intercooler between the first and the upstream compressor, in order that high overall pressure ratio, for example of 35:1 or more, could be reached otherwise exceeding the material temperature limits of the centre section of the gas turbine. The use of an intercooler can in addition reduce the overall work required for compression of the air to further increase the power output from the gas turbine.

According to a further exemplary embodiment of the present invention, the gas turbine includes a brake associated to the third shaft and a plurality of variable guide vanes at the inlet of the upstream compressor.

Advantageously, an air filtration system is arranged to filter the air flow entering the upstream compressor. The air flow then enters the first compressor.

Advantageously, the increase in operating range can be achieved by closing the VGVs on the upstream compressor and applying a brake to the third shaft to reach standstill. These actions will reduce the pressure of the air leaving the upstream compressor to sub atmospheric level and thereby the mass flow at the inlet of the first compressor with its pressure ratio maintained. This will result in a reduced pressure ratio over the second turbine, a lower power output and will lead to an increase in exhaust temperature which is beneficial for CO emission control.

Advantageously, due to the fact that the upstream compressor can be operated independently from the first compressor, it is possible to operate it in more than one way in order to change the mass flow through it, i.e. the mass flow rate through the upstream compressor can be changed by changing its speed alone, by changing the orientation of the VGVs without changing the speed, or, at the same time, by changing speed and VGVs orientation.

According to a further exemplary embodiment of the present invention, a method for upgrading a gas turbine assembly is provided. The initial gas turbine comprises a first shaft, a first compressor and a first turbine mounted on the first shaft, a combustor between the first compressor and the first turbine, a second shaft and a second turbine mounted on the second shaft, the second turbine having an inlet connected to an outlet of said first turbine. The method comprises the step of providing an upstream compressor mounted on a third shaft, the further step of connecting an outlet of the upstream compressor to an inlet of the first compressor and the further step of upgrading the size of the second turbine in order to increase the power output of the second turbine proportionally to the pressure ratio of the upstream compressor.

The fact that to accommodate the new mass flow and increased power output the power turbine is increase in size correspondingly leaves the original first compressor and first turbine unchanged in size and cost. In addition, if, in the upgrade, the design temperatures for the combustor and the second turbine exhaust are maintained from the original design, the partial load operating range can be significantly increased, before temperature limits are reached.

It has to be noted that embodiments of the invention have been described with reference to different subject matters. In particular, some embodiments have been described with reference to apparatus type claims whereas other embodiments have been described with reference to method type claims. However, a person skilled in the art will gather from the above and the following description that, unless other notified, in addition to any combination of features belonging to one type of subject matter also any combination between features relating to different subject matters, in particular between features of the apparatus type claims and features of the method type claims is considered as to be disclosed with this application.

### BRIEF DESCRIPTION OF THE DRAWINGS

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

FIG. 1 illustrates a schematical view of an exemplary embodiment of a gas turbine according to the present invention,

FIGS. 2 and 3 illustrate two schematical views of two respective conventional two-shaft gas turbines.

### DETAILED DESCRIPTION

The illustrations in the attached drawing are schematic. It is noted that in different figures similar or identical elements are provided with the same reference signs.

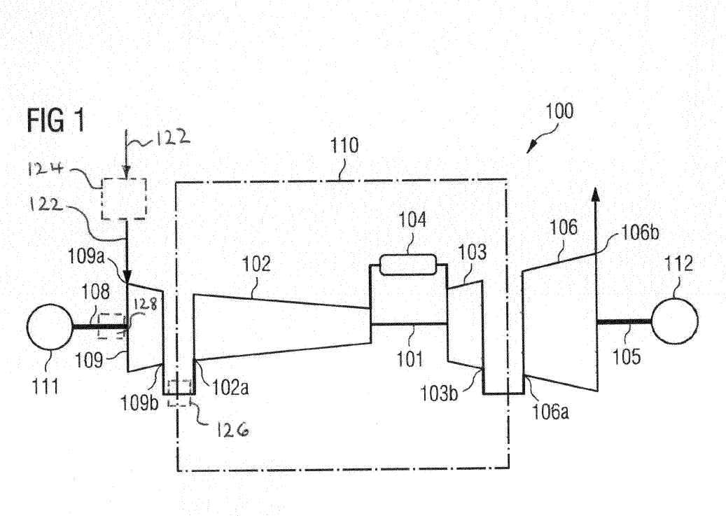

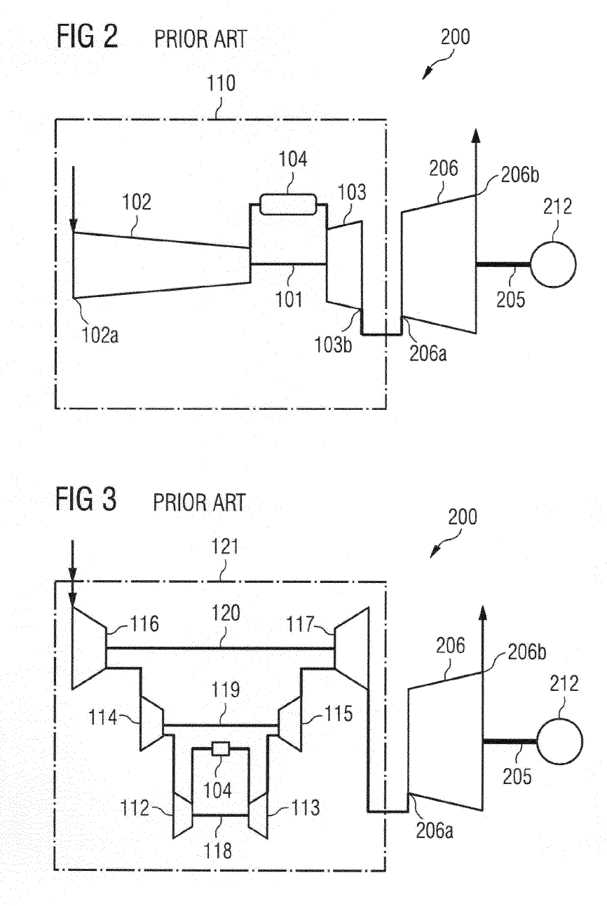

FIG. 1 shows a twin shaft gas turbine assembly 100 according to the present invention. The gas turbine assembly 100 may be manufactured directly or may be obtained as an upgrade for the existing gas turbine assembly 200 as shown in FIG. 2 (or FIG. 3) above. The gas turbine assembly 100 includes a gas generator 110 (or, as an alternative embodiment, a gas generator 121) and a second power turbine 106, connected to an electrical generator 112 by means of a second shaft 105. The second power turbine 106 includes an inlet 106a which is connected to the outlet 103b of the turbine 103 of gas generator 110. The second power turbine 106 and electrical generator 112 are analogue in function, respectively, to the second power turbine 206 and electrical generator 212 of the conventional twin shaft gas turbine assembly 200. The second power turbine 106 further comprises an outlet 106b.

The gas turbine assembly 100 further comprises a third shaft 108 on which an upstream compressor 109 is mounted. The upstream compressor 109 includes an inlet 109a through which a mass flow of air, e.g. atmospheric air, enters the upstream compressor 109 and an outlet 109b which is connectable to an inlet 102a of the first compressor 102 of the gas generator 110.

The gas turbine assembly 100 further comprises an air flow 122 and an air filtration system 124. The air flow 122 can be an ambient or atmospheric air source. The air flow 122 is ducted into and through the air filtration system 124 to ensure suitable filtered air is supplied to the upstream or upstream compressor 109 before being ducted and supplied to the first compressor 102. Advantageously, the two compressors 109 and 102 are in series and which allows the use of a common air filtration system for both compressors 109, 102.

According to a different embodiment (not shown) the outlet 109b of the upstream compressor 109 is connected to an inlet of one of the compressors 112, 114, 116 of the gas generator 121.

The upstream compressor 109 comprises a plurality of variable guide vanes (not shown in the schematic views of the attached figures) at the inlet 109a. A brake128 is provided on the third shaft 108 for preventing the rotation of the shaft 108 and, in particular, for achieving standstill. The brake 128 can be a standalone system as shown in dashed lines in FIG. 1 or the brake can be part of or integral to the electric motor 111. Indeed the electric motor or other controlled motor 111 can be operated as a braking mechanism for the shaft 108 and upstream compressor 109.

The upstream compressor 109 is designed for high efficiency and over a wide operating range. The number of compressor stages depends on the pressure ratio of the upstream compressor. The efficiency of the compressor stage is dependent on the pressure ratio for the stage as well as the inlet Mach number. A low number of stages in the upstream compressor are advantageous to reduce cost and complexity.

In operation, the outlet 109b of the upstream compressor 109 can be either connected or disconnected to the inlet 102a of the first compressor 102, for example by opening or completely closing the VGVs of the upstream compressor 109. When connected to the first compressor 102, the upstream compressor 109 permits an increase in the mass flow rate through the gas turbine 100, even if a high specific flow compressor is used as the first compressor 102. A further way of disconnecting the upstream compressor 109 from the first compressor 102 is that of applying the brake to third shaft 108 of the upstream compressor 108, alone or in cooperation with the VGVs closure.

In case of upgrading from the existing gas turbine 200 shown in FIG. 2 or 3, the mass flow rate and power output are increased proportionally to the pressure ratio of the upstream compressor 109. To accommodate the new mass flow and increased power output, the power turbine 106 and generator 112 need to be correspondingly greater in size, with respect to the original power turbine 206 and generator 212. This will leave the original gas generator 110 unchanged in size and cost.

According to a possible embodiment of the present invention, to reduce the overall length and cost, providing a compact design of the upgraded gas turbine 200 the inlet bearing of the first compressor and the outlet bearing, or the only bearing if in overhung configuration, of the upstream compressor may share a common bearing housing. The spokes providing services to the bearing (e.g. lubrication oil, air and instrumentation) may reach through the gas path ducting air from the upstream to the first compressor.

When connected to the upstream compressor 109, the working of the gas turbine 100 at partial load can be managed without changing the pressure ratios in the gas generator 110 or 121. Maintaining the pressure ratios in the gas generator 110 at their design optimum values allows component efficiencies to remain high but also the emissions to be kept low, in particular CO.

The gas turbine 100 further comprises a variable speed electrical motor 111 connected to the third shaft 108 for driving the upstream compressor 109 independently from the gas generator 110 and the second power turbine 106. By controlling the electric motor 111, as a driver, the user can control the speed of the upstream or second compressor 109. Therefore, the speed of the upstream compressor 109 can be controlled independently of the air flow passing through it. Thus the electric motor 111 is one of a number of controlled motors 111 that can be used to independently vary the speed of the shaft 108 and upstream compressor 109. Other controlled motors 111 can include a hydraulic motor and a reciprocating motor for example. Furthermore, the electric motor 111 can operate as a brake

The upstream compressor 109 has a pressure ratio selected to achieve an optimal overall pressure ratio between the inlet 109a of the upstream compressor 109 and the outlet of the first compressor 102, in order to have high cycle efficiency, high power output and low emissions.

According to a different embodiment the gas turbine assembly 100 comprises an intercooler 106 between the first compressor 102 and the upstream compressor 109, in order not to exceed the material limits of the centre section of the gas turbine, in case high overall pressure are reached, or in order to increase the power output from the gas turbine.

As will be appreciated another aspect of the present invention is a method of operating the gas turbine assembly 100 as described above. The method of operation comprises controlling the controllable motor 111 such that it controls of varies the speed of the upstream compressor 109 by varying the speed of the third shaft 108. This control of the shaft speed is in order to control the mass flow rate through the first compressor 102 and the first turbine 103. The method can include the step of holding the pressure ratio of the first compressor 102 approximately constant so that the compressor operates at its optimum design capability and therefore efficiently. At this stage it is advantageous for the pressure ratio of the upstream compressor 109 to be greater than 0.9.

Further steps in the operational method and in order to control the mass flow through the engine to an optimum design level include changing the positions of the plurality of variable guide vanes situated at the inlet 109a of the upstream compressor 109. Altering the angle of the guide vanes alters the amount of work done on the mass flow of the air by the compressor and controls the mass flow rate through the first compressor 102 and the first turbine 103.

With the arrangement of the gas turbine assembly it is also possible to improve and control engine start up and ignition. By increasing the speed of the upstream compressor 109, via the controllable motor 111, the speed of the first shaft 101 increases until ignition conditions in the combustor 104 are reached. During and after ignition, continuing to control the speed of the upstream compressor 109, via the controllable motor 111, advantageously raises the pressure ratio over the first turbine 103 and achieves a steady acceleration of the first shaft 101. Once ignition and combustion is established and is self-sustaining, reducing the speed of the upstream compressor 109 until the second turbine starts to generate mechanical power.

A further step of operation includes closing the plurality of variable guide vanes at the inlet 109a of the upstream compressor 109. This reduces the pressure ratio across the engine which enables operation of the gas turbine engine at a lower load where the mass flow is reduced yet the volume of air flow remains constant and therefore the turbomachinery operates at or near its optimal design point and thus the engine remains at a high efficiency.

Finally, the method of operating the gas turbine assembly 100 can include braking and shutting down of the upstream shaft 108 and compressor 109 via the brake 128. An air flow can still pass through the stationary upstream compressor 109 while the first compressor 102 and turbine continue to operate. Nonetheless, this step can also be employed to shut down the entire engine.

Closing the variable guide vane during braking can be useful to ensure a positive pressure ratio through the engine is maintained and to prevent surging or reverse flow which can otherwise damage components of the engine and its ancillaries.

1. A gas turbine assembly comprising:
a first shaft,
a first compressor and a first turbine mounted on the first shaft,
a combustor between the first compressor and the first turbine, and
a second turbine having an inlet connected to an outlet of the first turbine,
a third shaft on which a controllable motor and an upstream compressor are mounted, the upstream compressor having an outlet which is connected to an inlet of the first compressor,
wherein the controllable motor varies the speed of the third shaft and upstream compressor independently from an air flow passing through the upstream compressor,
wherein the air flow is ducted through the upstream compressor and the first compressor in series.

2. The gas turbine assembly of claim 1, further comprising:
a second drive shaft connected to the second turbine providing a torque to drive a mechanical load or a generator.

3. The gas turbine assembly of claim 1,
wherein the controllable motor is an electrical motor.

4. The gas turbine assembly of claim 1,
wherein the upstream compressor has a pressure ratio of 1/3 or lower of the pressure ratio for the first compressor, and
the pressure ratio for the first compressor is the pressure ratio at full load.

5. The gas turbine assembly of claim 1,
wherein the upstream compressor has a pressure ratio of 1/5 or lower of the pressure ratio of the first compressor.

6. The gas turbine assembly of claim 1,
wherein the upstream compressor has a pressure ratio of 1/10 or lower of the pressure ratio of the first compressor.

7. The gas turbine assembly of claim 1, further comprising:
an intercooler between the first compressor and the upstream compressor.

8. The gas turbine assembly of claim 1, further comprising:
a common bearing housing between the inlet bearing of the first compressor and the outlet bearing of the upstream compressor.

9. The gas turbine assembly of claim 1, further comprising:
a brake associated to the third shaft for preventing the rotation thereof and a plurality of variable guide vanes at the inlet of the upstream compressor.

10. The gas turbine assembly of claim 1, further comprising:
an air filtration system arranged to filter the air flow entering the upstream compressor.

11. A method for operating the gas turbine assembly of claim 1, the method comprising:
varying the speed of the upstream compressor by varying the speed of the third shaft in order to control the mass flow rate through the first compressor and the first turbine.

12. The method of claim 11, further comprising:
holding the pressure ratio of the first compressor approximately constant and wherein the pressure ratio of the upstream compressor is greater than 0.9.

13. The method of claim 11, further comprising:
changing the positions of the plurality of variable guide vanes at the inlet of the upstream compressor in order to control the mass flow rate through the first compressor and the first turbine.

14. The method of claim 11, further comprising:
increasing the speed of the upstream compressor to increase the speed of the first shaft until ignition conditions in the combustor are reached,
continuing to control the speed of the upstream compressor in order to raise the pressure ratio over the first turbine and achieve a steady acceleration of the first shaft,
reducing the speed of the upstream compressor until the second turbine starts to generate mechanical power.

15. The method of claim 11, further comprising:
closing the plurality of variable guide vanes at the inlet of the upstream compressor.

16. The method of claim 11, further comprising:
operating the brake associated to the third shaft for achieving standstill of the third shaft.
